(19) United States
(12) Patent Application Publication
(10) Pub. No.: US 2025/0096618 A1
(43) Pub. Date: Mar. 20, 2025

(54) TELEMETRY VIA WIRELESS POWER TRANSFER

(71) Applicant: Resonant Link, Inc., South Burlington, VT (US)

(72) Inventors: Milovan Kovacevic, Palo Alto, CA (US); Scott Warren, Jericho, VT (US); Shehadeh Dajani, Los Angeles, CA (US); Sai Chun Tang, Auburndale, MA (US); Aaron Stein, Essex, VT (US); Phyo Aung Kyaw, Winooski, VT (US)

(73) Assignee: Resonant Link, Inc., South Burlington, VT (US)

(21) Appl. No.: 18/794,081

(22) Filed: Aug. 5, 2024

Related U.S. Application Data
(63) Continuation of application No. PCT/US2023/012716, filed on Feb. 9, 2023.
(60) Provisional application No. 63/418,123, filed on Oct. 21, 2022.
(60) Provisional application No. 63/308,689, filed on Feb. 10, 2022.

(51) Int. Cl. H02J 50/80; H02J 50/12

(52) U.S. Cl. CPC H02J 50/80; H02J 50/12

(57) ABSTRACT

A power switch of a wireless power transmitter or a wireless power receiver is controlled to create a perturbation that transmits information from the wireless power transmitter or wireless power receiver to the other of the wireless power transmitter and wireless power receiver.

### RELATED APPLICATIONS

This application is a Continuation of International Patent Application Serial No. PCT/US2023/012716, filed Feb. 9, 2023, titled “TELEMETRY VIA WIRELESS POWER TRANSFER”, which claims the benefit of U.S. Provisional Application Ser. No. 63/308,689, filed Feb. 10, 2022, titled “TELEMETRY VIA WIRELESS POWER TRANSFER,” and U.S. Provisional Application Ser. No. 63/418,123 filed Oct. 21, 2022, titled “TELEMETRY VIA WIRELESS POWER TRANSFER,” each of which is incorporated herein by reference in its entirety.

### BACKGROUND

### 1. Technical Field

The apparatus and techniques described herein relate to communication between a wireless power transmitter and a wireless power receiver.

### 2. Discussion of the Related Art

Power can be transmitted wirelessly from a wireless power transmitter to a wireless power receiver using electromagnetic induction. An alternating current is driven through a transmit coil of the wireless power transmitter, which produces a magnetic field that induces an alternating current in a receive coil of the wireless power receiver. The received signal may then be rectified and further processed. The level of power that is transferred can be variable and may depend upon the strength of the magnetic coupling between the transient and receive coils.

### SUMMARY

Some aspects relate to a method of transmitting data in a wireless power system, the method comprising: controlling a power switch of a wireless power transmitter or a wireless power receiver to create a perturbation that transmits information from the wireless power transmitter or wireless power receiver to the other of the wireless power transmitter and wireless power receiver.

The controlling of the power switch may comprise modulating a power switch of a rectifier of the wireless power receiver.

The power switch may be coupled in parallel with a diode of the rectifier.

The controlling of the power switch may comprise modulating a power switch of an inverter of the wireless power transmitter.

The controlling of the power switch may comprise stopping switching of the power switch of the inverter.

The controlling of the power switch may comprise shorting one or more low-side power switches of the rectifier or inverter.

The controlling of the power switch may comprise holding one or more power switches of the rectifier or inverter in an existing state past a point in time of an alternating current waveform at which the one or more power switches switch when no perturbation is created.

The method may further comprise varying a duration between perturbations or a duration of the perturbation based on information regarding one or more system parameters.

The one or more system parameters may comprise power level, magnetic coupling and/or an error signal.

The method may further comprise varying a duration between perturbations or a duration of the perturbation to encode information in a duration of the perturbation or a duration between perturbations.

The information may be transmitted from the wireless power receiver to the wireless power transmitter.

The information may be transmitted from the wireless power transmitter to the wireless power receiver.

Some aspects relate to a method of receiving data in a wireless power system that includes a wireless power transmitter and a wireless power receiver, the method comprising: detecting, by the wireless power receiver or a wireless power transmitter, a perturbation in coupling of power transfer between the wireless power receiver and the wireless power transmitter.

The detecting of the perturbation may comprise detecting a change in amplitude of a signal produced through the coupling.

The detecting of the change in amplitude may comprise detecting an amplitude exceeding a threshold to produce a pulse, and providing the pulse to a monostable circuit to provide a second pulse of fixed width.

The detecting may comprise detecting a change in frequency of a signal produced though the coupling.

The detecting of the change in frequency may be performed at least in part by detecting signal amplitudes exceeding a threshold to produce pulses, and detecting an interval between the pulses.

Some aspects relate to an apparatus comprising circuitry configured to perform any of the methods described above or hereinbelow.

Some aspects relate to an apparatus, comprising: a controller configured to control a power switch of an inverter of a wireless power transmitter or a rectifier of a wireless power receiver to create a perturbation that transmits information between the wireless power transmitter and the wireless power receiver.

The apparatus may further comprise the rectifier.

The apparatus may further comprise the inverter.

A wireless power transmitter or wireless power receiver may comprise the apparatus.

Some aspects relate to at least one non-transitory computer readable storage medium having stored thereon instructions, which, when executed by a processor, perform any of the methods described above or hereinbelow.

Some aspects relate to an apparatus for controlling transmitting data in a wireless power system, the apparatus comprising: a controller configured to control a power switch of a wireless power transmitter or a wireless power receiver to create a perturbation that transmits information from the wireless power transmitter or wireless power receiver to the other of the wireless power transmitter and wireless power receiver.

The controller may be configured to modulate a power switch of a rectifier of the wireless power receiver.

The power switch may be coupled in parallel with a diode of the rectifier.

The controller may be configured to modulate a power switch of an inverter of the wireless power transmitter to create the perturbation.

The controller may be configured to stop switching of the power switch of the inverter to create the perturbation.

The controller may be configured to turn on one or more low-side power switches of the rectifier or inverter to create the perturbation.

The controller may be configured to hold one or more power switches of the rectifier or inverter in an existing state past a point in time of an alternating current waveform at which the one or more power switches switch when no perturbation is created.

The controller may be configured to vary a duration between perturbations or a duration of the perturbation based on information regarding one or more system parameters.

The one or more system parameters may comprise power level, magnetic coupling and/or an error signal.

The controller may be configured to vary a duration between perturbations or a duration of the perturbation to encode information in a duration of the perturbation or a duration between perturbations.

The information may be transmitted from the wireless power receiver to the wireless power transmitter.

The information may be transmitted from the wireless power transmitter to the wireless power receiver.

Some aspects relate to an apparatus for receiving data in a wireless power system that includes a wireless power transmitter and a wireless power receiver, the apparatus comprising: a data receiver configured to detect a perturbation in a coupling between the wireless power receiver and the wireless power transmitter.

The data receiver may be configured to detect a change in amplitude of a signal produced through the coupling.

The data receiver may be configured to detect an amplitude exceeding a threshold to produce a pulse, and provide the pulse to a monostable circuit to provide a second pulse of fixed width.

The data receiver may be configured to detect a change in frequency of a signal produced though the coupling.

The data receiver may be configured to detect the change in frequency at least in part by detecting signal amplitudes exceeding a threshold to produce pulses, and detect an interval between the pulses.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows a block diagram illustrating a wireless power transfer system in which a wireless power transmitter communicates with a wireless power receiver through the inductive link used to send power from the wireless power transmitter to the wireless power 5 receiver.

FIG. 2 shows an example of a wireless power receiver that can transmit data by controlling the power devices of its rectifier, according to some embodiments.

FIG. 3A illustrates an example of circuitry for a wireless power receiver.

FIG. 3B shows an example of the waveforms illustrating a technique in which all four switches of the synchronous rectifier are held in their state beyond the time of the zero-crossing of the input current.

FIG. 3C shows an example for a holding state that additionally illustrates creating the perturbation using the Rx control signal, which produces a perturbation command pulse.

FIG. 3D shows an example of the waveforms for a technique in which the perturbation is created by delaying a turn-off event on all 4 switches which modulates rectifier impedance.

FIG. 4A shows an example of circuitry for a wireless power transmitter including an inverter that may be controlled by a controller to transmit power wirelessly by driving an ac current through the transmit coil.

FIG. 4B shows an example of a wireless power transmitter in greater detail, according to some embodiments.

FIG. 5A shows a timing diagram illustrating, among other things, the signal detected at the wireless power transmitter following the perturbation at the wireless power receiver.

FIG. 5B shows an example of a wireless power receiver including a receive coil and a rectifier.

FIG. 5C shows plots of example waveforms for different power levels illustrating the effect of a perturbation created at the wireless power transmitter by stopping the switching of the inverter switches.

FIG. 6 illustrates how a plurality of values may be transmitted in a single PETV packet through the use of sectioning packets.

FIG. 7 shows the increased performance of PETV in terms of packet frequency with respect to UART.

FIG. 8 shows examples of waveforms of the telemetry system including the shorting pulses and the power inverter output current.

FIG. 9 shows an example of a circuit implementation of a data receiver which may be implemented at the wireless power transmitter.

### DETAILED DESCRIPTION

To control wireless power transfer, the wireless power receiver may send information to the wireless power transmitter. Conventionally, a dedicated wireless communication channel is used for this purpose. Examples of wireless communication technologies that may be used for the dedicated wireless communication channel include Bluetooth and WiFi. However, including a dedicated communication channel may increase power usage and add cost. For example, in an implant, it may be desirable to minimize power consumption to maximize battery life and/or reduce heating within the body. Additionally, a dedicated communication channel using standard protocols may be vulnerable to hacking.

In some embodiments, information may be transmitted through the inductive coupling by which power is transmitted from the wireless power transmitter to the wireless power receiver. In some embodiments, information may be transmitted by modulating the circuitry at the wireless power receiver or the wireless power transmitter to create a perturbation that transmits information through the magnetic field, which is then detected by the other device. For example, the wireless power receiver may modulate its impedance, which may be observed by the wireless power transmitter through a change in the magnetic field present at the wireless power transmit coil, and information may be transmitted from the wireless power receiver to the wireless power transmitter through the impedance modulation. Alternatively or additionally, the wireless power transmitter may create a perturbation by controlling the power switches of an inverter that generates the alternating current supplied to its transmit coil, which may be observed by the wireless power receiver through a change in the magnetic field present at the receive coil. In some embodiments, the power components (e.g., transistors, which may be MOSFETS or BJTs, but not limited thereto) of the power electronics (e.g., rectifier or inverter) may be modulated to create the perturbation. In some embodiments, no dedicated communication link (e.g., WiFi or Bluetooth) is needed between the wireless power transmitter and wireless power receiver, as information may be sent through perturbations created in the magnetic field that provides the wireless power transfer. This can reduce or eliminate the need for dedicated communication module at the wireless power transmitter and/or the wireless power receiver, which can provide advantages such as those described above. The principles and techniques described herein may be applied to either communication from the wireless power receiver to the wireless power transmitter, or to communication from the wireless power transmitter to the wireless power receiver.

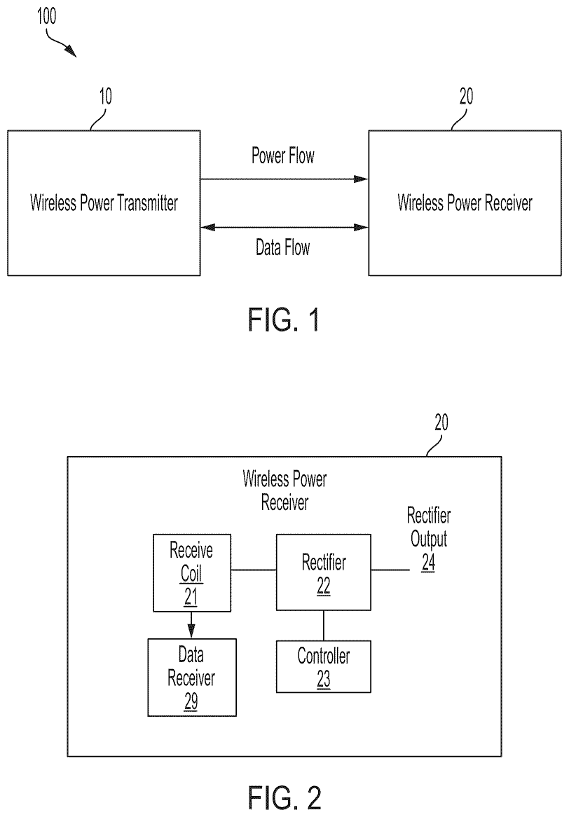

FIG. 1 shows a block diagram illustrating a wireless power transfer system 100 in which a wireless power transmitter 10 communicates with a wireless power receiver 20 through the inductive link used to send power from the wireless power transmitter 10 to the wireless power receiver 20. The wireless power receiver 20 may transmit data to the wireless power transmitter 10 by controlling the power devices in the wireless power receiver 20. For example, one or more power devices of a rectifier in the wireless power receiver 20 may be controlled in a manner that creates a perturbation that can be detected by the wireless power transmitter 10. For example, the perturbation may be a change in the impedance of the wireless power receiver 20 as seen by the wireless power transmitter 10. Alternatively or additionally, the wireless power transmitter 10 may transmit data to the wireless power receiver 20. For example, the wireless power transmitter 10 may create a perturbation by controlling the power switches of an inverter that generates the alternating current supplied to its transmit coil, and the perturbation may be detected by the wireless power receiver 20. In some embodiments, a perturbation at the wireless power receiver 20 may present as an amplitude modulation or peak at the wireless power transmitter 10. A perturbation at the wireless power transmitter 10 may present as a frequency modulated signal at the wireless power receiver 20. However, the techniques and apparatus described herein are not limited as to the perturbations producing particular modulations. Additionally, the data that is transmitted may be any data. In some cases, some or all of the data that is transmitted may be used to control wireless power transfer from the wireless power transmitter 10 to the wireless power receiver 20. However, the present disclosure is not limited as to the type of data that is transmitted.

FIG. 2 shows an example of a wireless power receiver 20 that can transmit data to a wireless power transmitter 10 by controlling the power devices of its rectifier 22, according to some embodiments. The receive coil 21 has an alternating current induced therein by the magnetic field produced by the wireless power transmitter 10. Optionally, the receive coil 21 may be coupled to a matching network (e.g., a capacitor), which is not shown in FIG. 2. The signal from the receive coil 21 (and optionally processed by the matching network) is then provided to the rectifier 22. The rectifier 22 receives the alternating current from the receive coil 21 and converts it into direct current at the rectifier output 24. The direct current may then be provided to any suitable load, such as a battery charger (not shown), for example. The rectifier 22 may be a full-bridge or half-bridge rectifier. The rectifier 22 may be a synchronous rectifier that is controlled by the controller 23 of the wireless power receiver. Alternatively, the rectifier may be a diode rectifier with switch(es) connected in parallel with one or more of the diodes and controlled by the controller 23 to create a perturbation at selected times. However, the devices and techniques described herein are not limited as to the particular type or implementation of rectifier 22. Regardless of the type of rectifier, one or more switches may be controlled to induce a perturbation that can be detected by the wireless power transmitter 10.

In this example, the wireless power receiver 20 also includes a data receiver 29 for receiving data transmitted from the wireless power transmitter 10, which is received by the wireless power receiver 20 through the inductive coupling to the receive coil 21. Although shown as coupled to the receive coil 21, the data receiver may be connected to a different portion of the wireless power receiver 20, such as rectifier 22, for example. In other embodiments in which the wireless power receiver 20 does not receive data from the wireless power transmitter 10, the data receiver 29 may be omitted. Data transmission from a wireless power receiver 20 to a wireless power transmitter 10 is discussed further below.

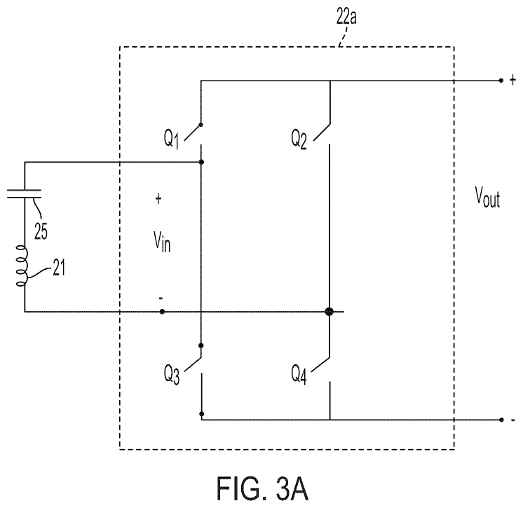

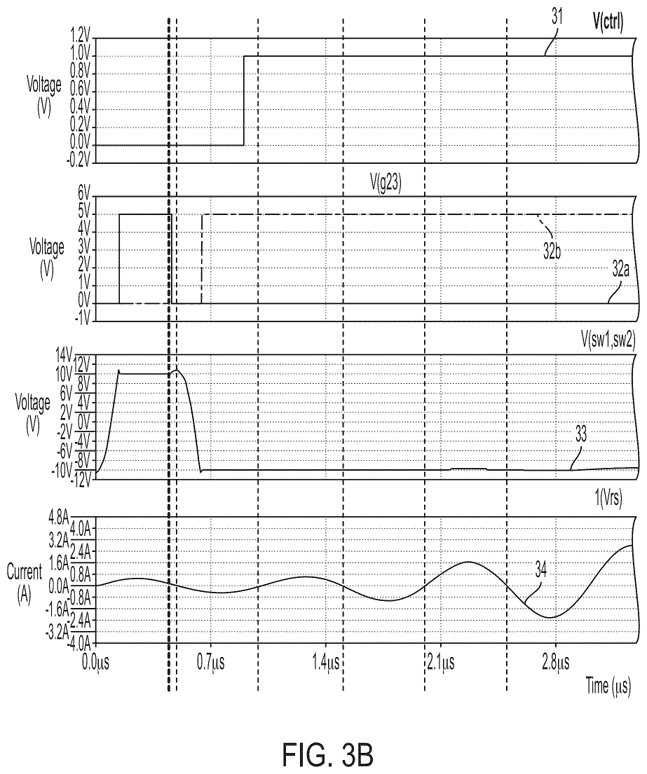

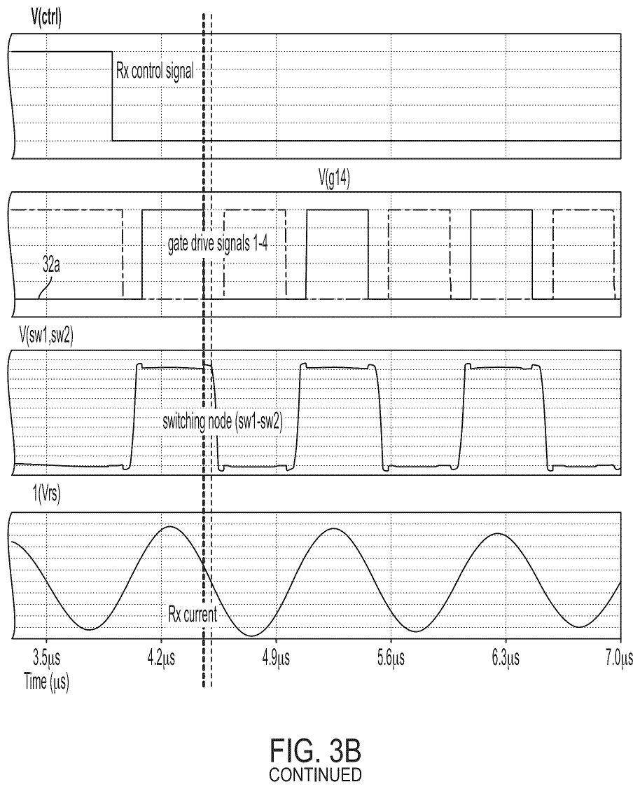

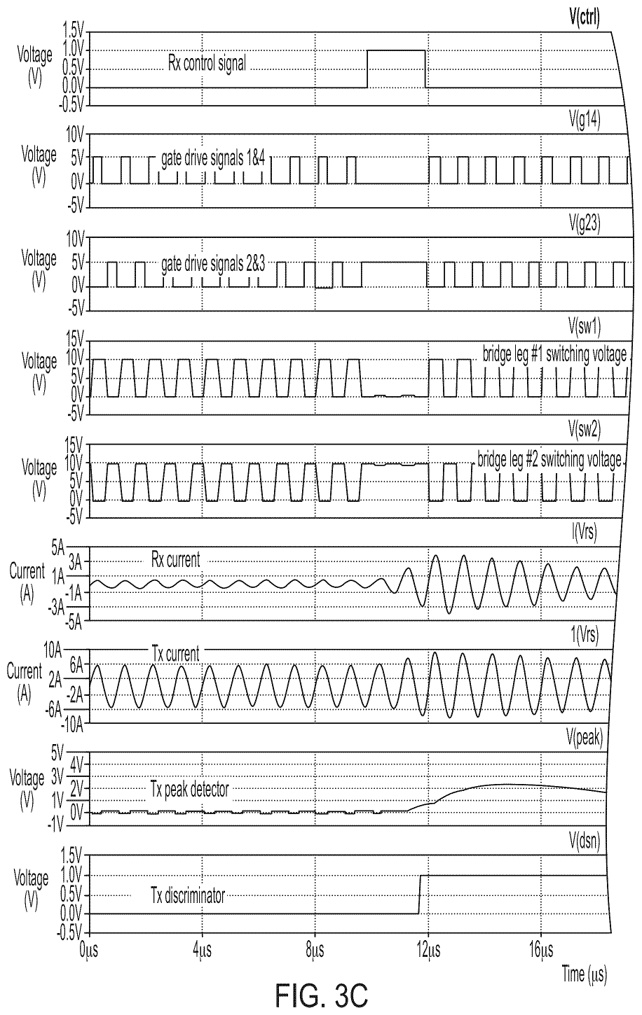

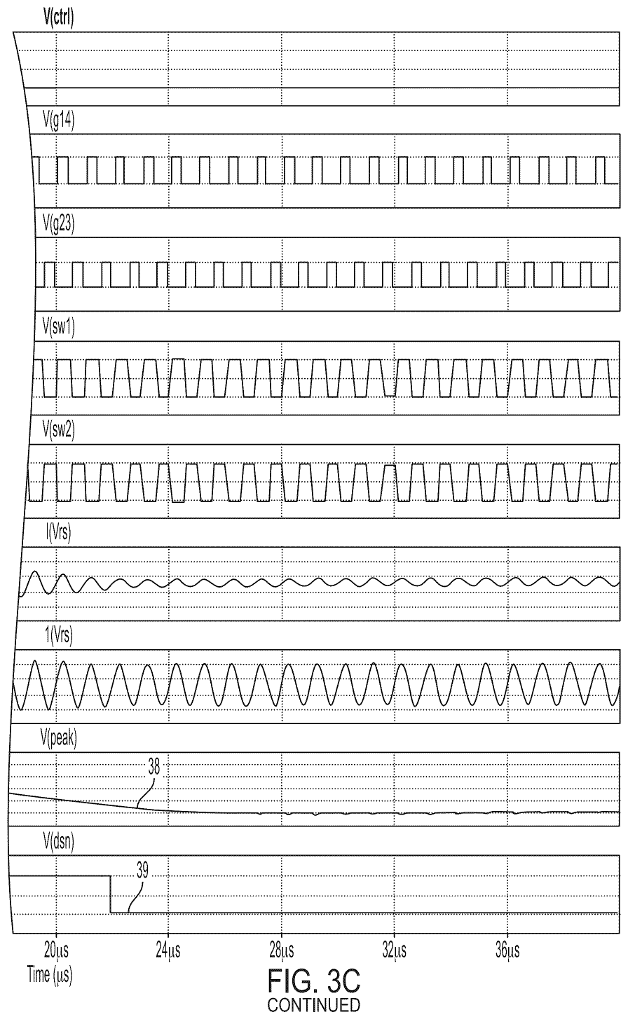

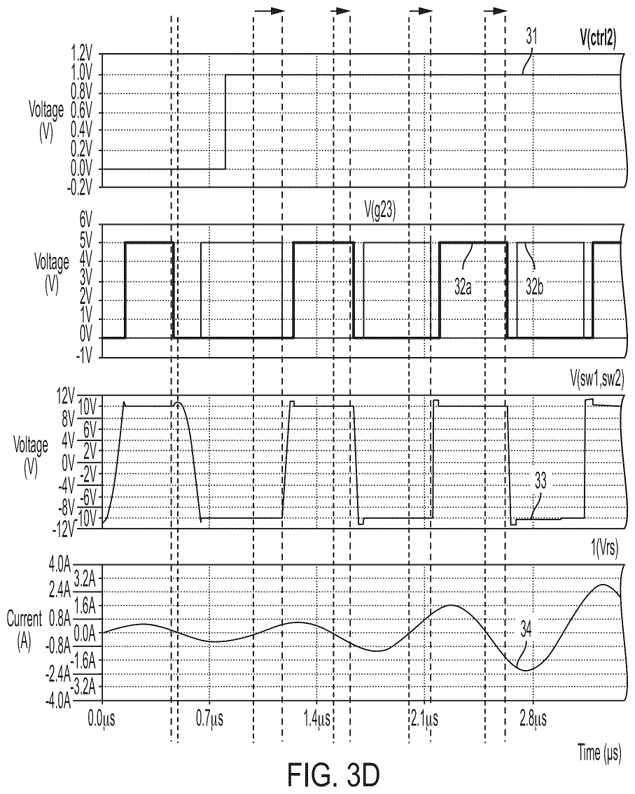

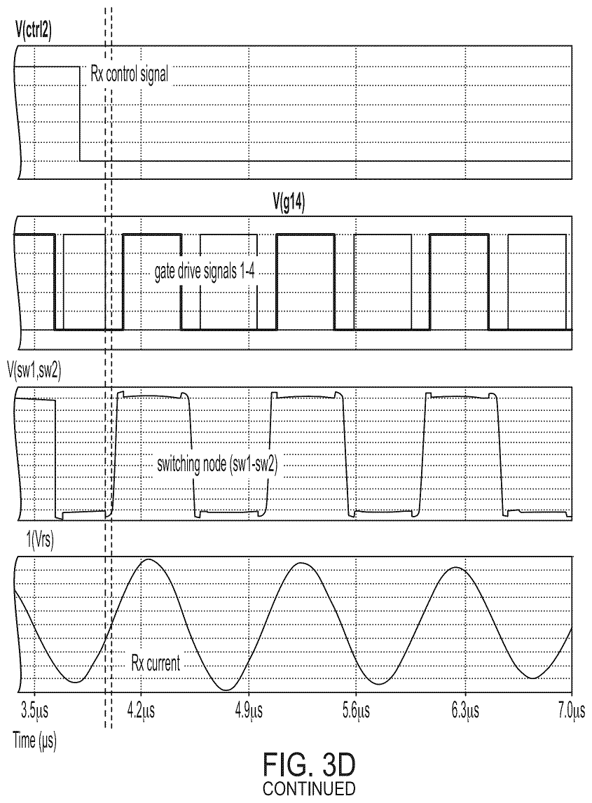

FIG. 3A illustrates an example of circuitry of a wireless power receiver including a receive coil 21, a matching network 25, here shown as a capacitor connected in series with the receive coil 21, and a rectifier 22, here shown as a full-bridge synchronous rectifier 22a having switches Q1-Q4. The typical mode of operation of the rectifier 22a as a rectifier is to turn on switches Q1 and Q4 during the half-cycles when the input voltage of the rectifier 22a is positive (while keeping Q2 and Q3 turned off), and to turn on switches Q2 and Q3 during the half-cycles when the input voltage of the rectifier 22a is positive (while keeping Q1 and Q4 turned off), thereby converting an alternating current input into a direct current output. To transmit information to the wireless power transmitter 10, this typical mode of operation of the rectifier 22a may be modified to generate a perturbation (e.g., in the magnetic field) that may be detected at the wireless power transmitter.

### Creating the Perturbation

The perturbation may be generated by a rectifier in a variety of ways.

Below examples are described of ways in which the perturbation may be generated using the full-bridge synchronous rectifier 22a (FIG. 3A).

One example is to hold all four switches (Q1-Q4) of the synchronous rectifier 22a in a holding state. In this technique, all four switches (Q1-Q4) of the synchronous rectifier may be held in their state beyond the time of the zero-crossing of the input current. FIG. 3B shows an example of the waveforms for such a technique for a rectifier as shown in FIG. 3A. As illustrated in FIG. 3B, the holding state is activated when the perturbation pulse command signal 31 goes high, which holds the gate drive signals 32a, 32b, for the switches Q1-Q4 in a constant state. The input voltage of the rectifier is shown as waveform 33. The holding state may occur over multiple periods of the received AC signal. FIG. 3B shows the holding state increases the current in the receive coil 21, as illustrated by waveform 34, which in turn causes an increase in the current through the transmit coil of the wireless power transmitter 10. FIG. 3C shows an example for a holding state that additionally illustrates the increase in the current and demodulated signal 39 that may be produced by comparing the envelope signal 38 to a threshold.

Another example of a way of creating the perturbation is to hold two of the four switches of the synchronous rectifier 22a in a holding state. In this technique, two switches of the synchronous rectifier are held in their state beyond the time of the zero-crossing of the input current. Examples include the pair of switches Q1 and Q4 and the pair of switches Q2 and Q3. To create the perturbation the two switches may be held in the on state (conductive) or the off state (non-conductive) for a period of time beyond that which occurs in their normal operation, which corresponds to the switching of an ideal diode.

Another example of a way of creating the perturbation is to short two of the four switches of the synchronous rectifier 22a, such as the two low-side switches (Q3 and Q4) or the two high-side switches (Q1 and Q2). In this technique, the perturbation is created by turning on two low side switches (Q3 and Q4), or two high side switches (Q1 and Q2). This operation is effectively shorting the receiver coil.

Another example of a way of creating the perturbation is to delay a turn-off event on all four switches of the synchronous rectifier 22a, which modulates rectifier impedance. FIG. 3D shows an example of the waveforms for such a technique for a rectifier as shown in FIG. 3A. The delay in the turn-off events are shown by the time delay between the dashed lines, as illustrated by arrows.

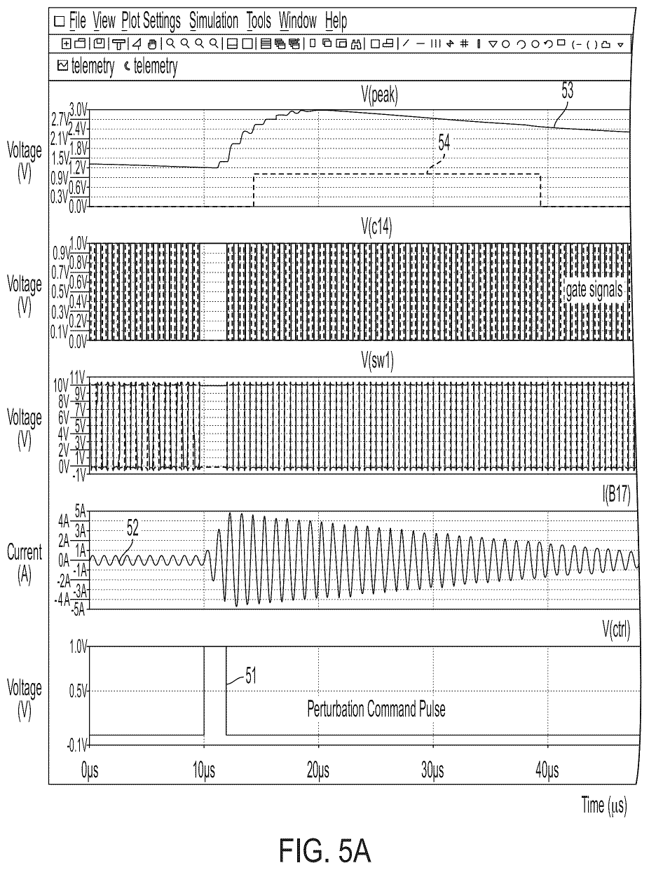

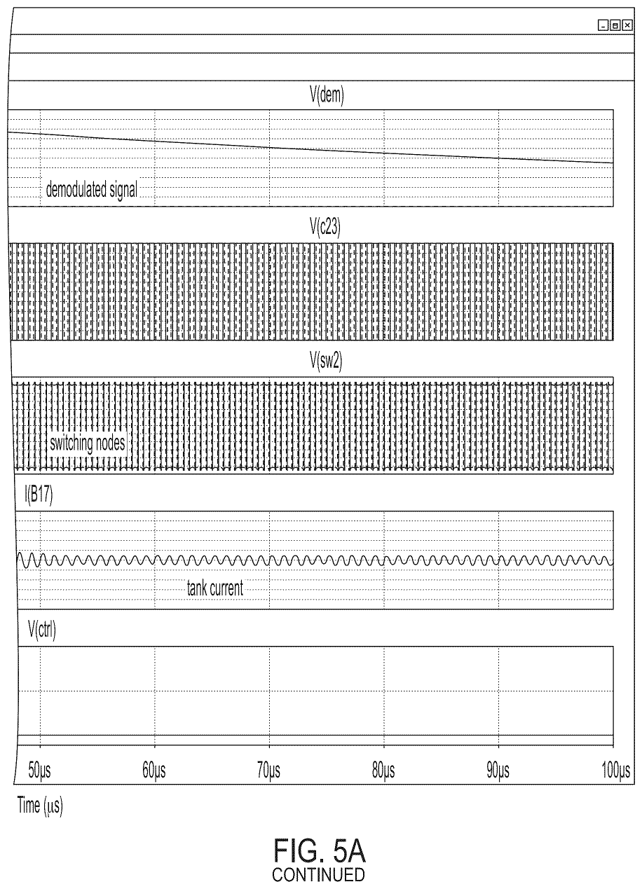

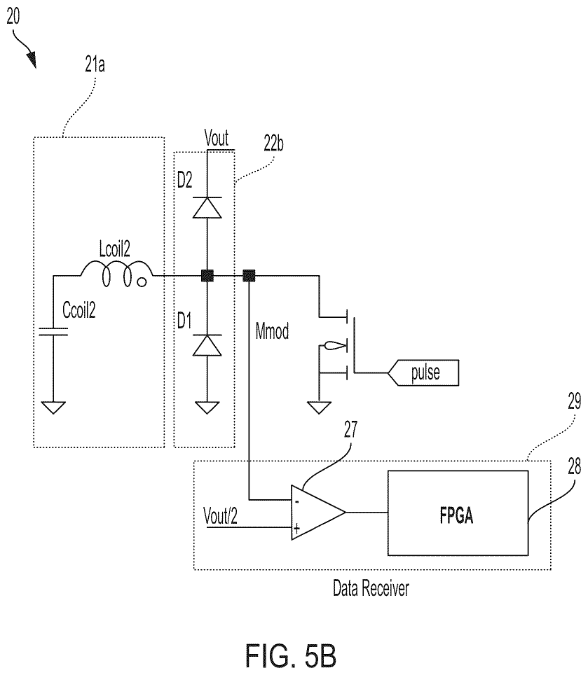

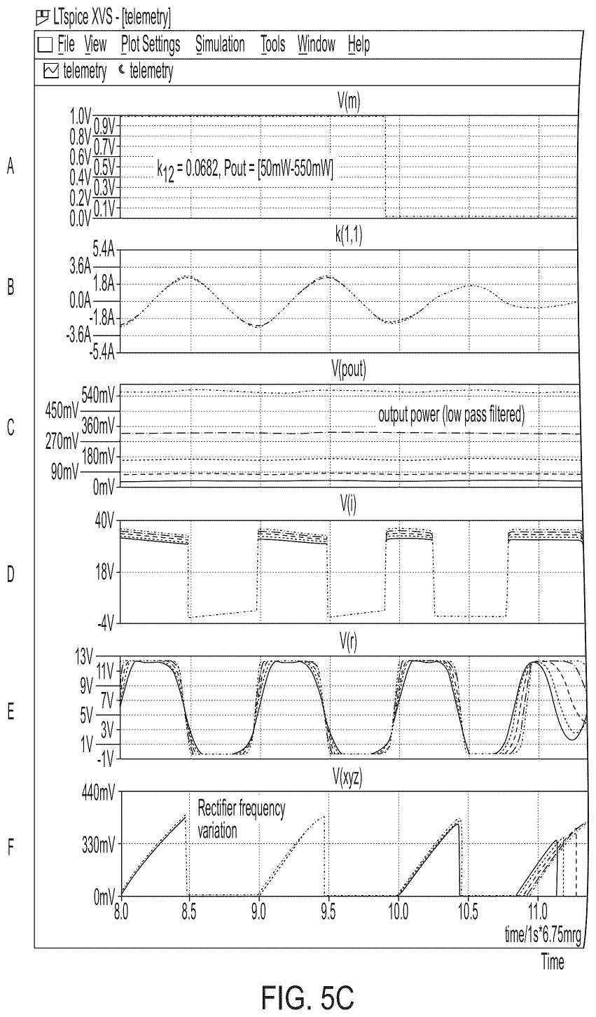

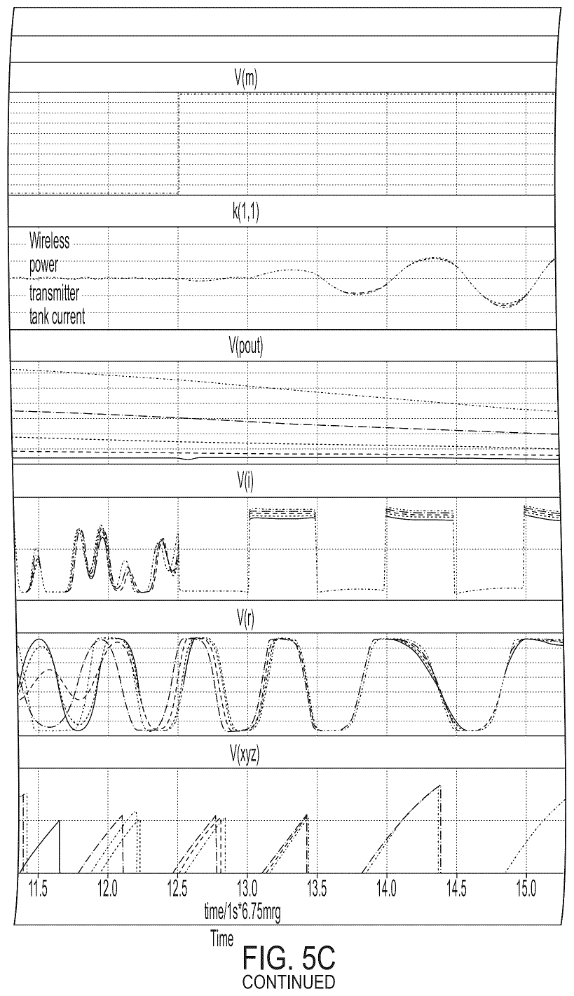

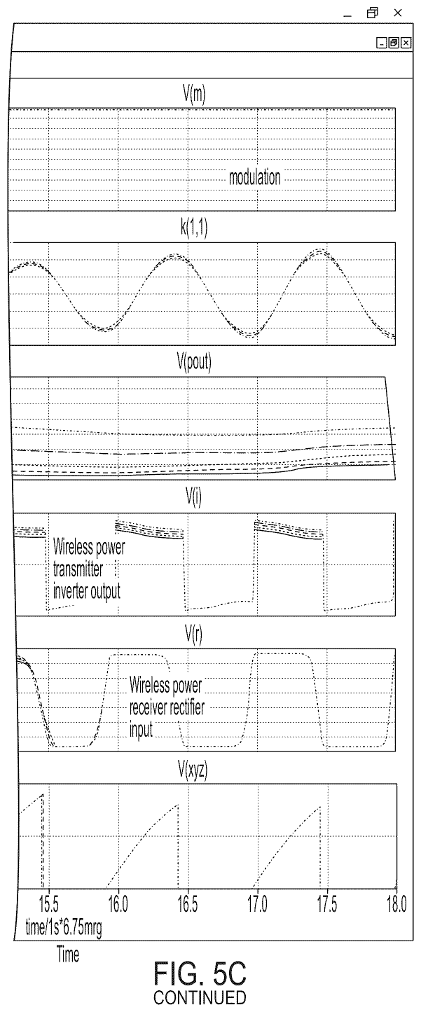

Below examples of ways in which the perturbation may be generated using a half-bridge synchronous rectifier. A half-bridge synchronous rectifier may be implemented in a similar configuration to the half-bridge diode rectifier 22b shown in FIG. 5b, but with the diodes D1 and D2 replaced by switches.

One example is to hold both of the switches of the synchronous rectifier in a holding state. Similarly to the technique described above for a full-bridge synchronous rectifier and illustrated in FIG. 3B, in this technique all (both) switches of the synchronous rectifier are held in their state beyond the time of the zero-crossing of the input voltage for a plurality of switching cycles.

Another example of a way of generating perturbation is to delay a turn-off event on all (both) switches, which modulates rectifier impedance. This technique is similar to the technique described above for a full-bridge synchronous rectifier and illustrated in FIG. 3D.

Below are described examples of ways in which the perturbation may be generated using a half-bridge or full bridge diode rectifier. As mentioned above, an example of a half-bridge diode rectifier 22b is shown in FIG. 5B. A full-bridge diode rectifier may be implemented in a similar configuration to the full-bridge synchronous rectifier 22a of FIG. 3A, with the switches replaced by diodes in a suitable orientation. To create the perturbation in a diode rectifier, one or more switches may be connected in parallel with one or more of the diodes of half-bridge or full-bridge rectifier. The switching of the one or more switches can be controlled to create the perturbation.

One example of a way of creating the perturbation is to turn on the one or more switches, which shorts out the diode with which the switch is connected in parallel. Accordingly, rather the current can bypass the diode through the switch. This technique can be used for full-bridge or half-bridge rectifiers. Switches may be connected in parallel with any number of the diodes. The switche(s) may be turned on for a plurality of periods of the input alternating current waveform.

Another example of a way of creating the perturbation is to turn on the one or more switches in parallel with one or more diodes while the corresponding diode is conducting, and to keep the switch turned on for a period of time after the zero crossing of the input voltage, which creates a perturbation. Again, this technique can be used for full-bridge or half-bridge rectifiers. Also, switches may be connected in parallel with any number of the diodes.

These techniques and corresponding devices for creating the perturbation also apply to an inverter of a wireless power transmitter 10. A wireless power transmitter 10 may transmit information to a wireless power receiver 20 by creating a perturbation in the switching of an inverter that drives a wireless power transmit coil. As one example, a perturbation may be created by stopping the switching of the switches of the inverter for a number of cycles of the inverter switching waveform. Stopping the switching of the switches of the inverter briefly stops the transfer of power to the wireless power receiver 20, which causes a drop in the energy stored in the resonant tank of the receive coil 21 of the wireless power receiver 20. The drop in energy stored in the resonant tank can be detected by the wireless power receiver 20. Accordingly, information may be transmitted from the wireless power transmitter 10 to the wireless power receiver 20. In some cases, if the time period for which the switching is stopped is relatively short (e.g., less than 10 switching periods), there may be no interruption or only an insignificant disruption in the power provided to the load via the rectifier output 24.

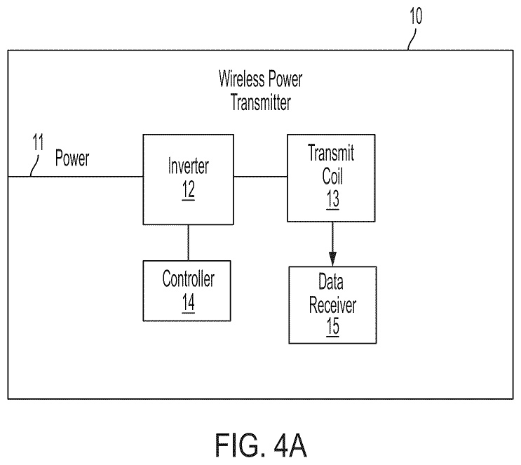

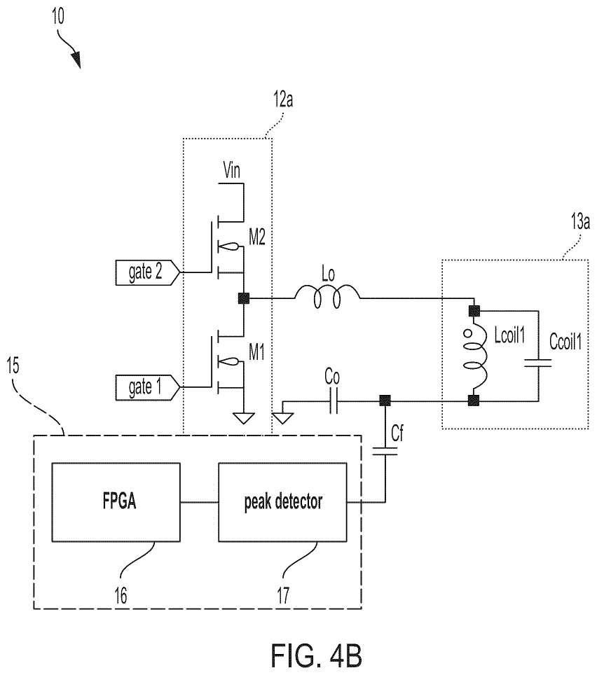

FIG. 4A shows an example of circuitry for a wireless power transmitter 10 including an inverter 12 receiving power from a power input 11. The inverter 12 may be controlled by a controller 14 to transmit power wirelessly by driving an alternating current through the transmit coil 13. In this example, the wireless power transmitter 10 also includes a data receiver 15 for receiving data transmitted from the wireless power receiver 20, which is received by the wireless power transmitter 10 through the inductive coupling to the transmit coil 13. Although shown as being coupled to the transmit coil 13, the data receiver 15 may be connected to other circuitry of the wireless power transmitter 10 such as the inverter 12, for example. In other embodiments in which the wireless power transmitter 10 does not receive data from the wireless power receiver 20, the data receiver 15 may be omitted.

FIG. 4B shows an example of a wireless power transmitter 10 in greater detail, including a half-bridge inverter 12a with switches M1 and M2 and a transmit coil 13a modeled by an inductor Lcoil1 and a capacitor Coil1 connected in parallel. However, in other embodiments the half-bridge inverter 12a may be replaced by a full-bridge inverter. Data receiver 15 may include circuitry for detecting the perturbation, including but not limited to an field programmable gate array (FPGA), other hardware, a controller, a processor, etc. and/or software/firmware. For example, data receiver 15 may include a field programmable gate array (FPGA) 16 and peak detector 17 to detect signals received from the wireless power receiver 20 through the inductive coupling to the transmit coil 13a. The peak detector 17 may detect peaks in the signals received inductively from the wireless power 20 through the transmit coil 13a. The peaks detected by the peak detector 17 may be analyzed by the FPGA 16 or any other suitable circuit for performing analysis of the signals from the peak detector 17.

As discussed above, to transmit information from the wireless power transmitter 10 to the wireless power receiver 20, the a perturbation may be created by modifying the switching of switches M1 and M2 with respect to nominal inverter operation. As an example, the switching of the switches M1 and M2 may be stopped for a period of time (e.g., several switching periods).

### Detecting the Perturbation

The perturbation created at the wireless power receiver 20 may cause energy build-up in the transmit and receive coils 13, 21, for a brief period of time. This can be detected as an increase in the current or voltage at the wireless power transmitter 10. As discussed above, FIG. 4A shows an example of circuitry for a wireless power transmitter 10, including an inverter 12 that may be controlled by a controller 14 to transmit power wirelessly by driving an alternating current through the transmit coil 13. When a perturbation is created at the wireless power receiver 20, the inductive coupling may cause the current or voltage in the transmit coil 13 to increase. Such an increase may be detected by the data receiver 15 which may include a peak detector 17, FPGA 16, and/or other suitable data receiver circuitry.

FIG. 5A shows a timing diagram illustrating, among other things, the signal detected at the wireless power transmitter 10 following the perturbation at the wireless power receiver 20. In this example, the wireless power receiver 20 produces a perturbation command pulse 51 to transmit information to the wireless power transmitter 10. The perturbation command pulse 51 commands the rectifier 22 to create the perturbation by modifying the switching of one or more power switches of the rectifier 22 in in a suitable way, such as described in the examples discussed above. The perturbation causes an increase in the tank current 52, which is the current through the wireless power receive coil 21. This results in a higher current at the wireless power transmit coil 13 for a period of time, which may be detected by the data receiver 15 as voltage waveform 53. This peak in the current at the transmit coil 13 can be detected and demodulated by the data receiver 15 as a demodulated signal 54. As shown in FIG. 5, the demodulated signal 54 is a logical low for the time that no peak is detected and a logical high for the time that the peak is detected. The peak may be interpreted as a logical high or a logical low, as the techniques described herein are not limited to particular logic levels (e.g., they may be reversed).

These techniques and corresponding devices for detecting the perturbation also apply to an inverter 12 of a wireless power transmitter 10 transmitting information to a wireless power receiver 20. FIG. 5B shows an example of a wireless power receiver 20 including a receive coil 21a represented by the series combination of Lcoil2 and Ccoil2, as well as a half-bridge diode rectifier 22b including diodes D1 and D2. However, as mentioned above, a different type of rectifier may be substituted including full-bridge and/or synchronous rectifiers. The wireless power receiver 20 also includes a data receiver 29 for detecting the reduction in energy stored in the wireless power receive coil tank including Lcoil2 and Ccoil2 in response to the reduction in power received by the wireless power transmitter 20 when the wireless power transmitter 10 creates a perturbation. The perturbation may be detected as a change in the current and/or voltage waveforms at the wireless power receiver 20. In this example, the data receiver 29 includes a comparator 27 that compares the voltage of the wireless power receive coil 21a to a threshold to produce a demodulated signal. Any suitable threshold may be used, such as half of the output voltage of the rectifier 22b (Vout/2) for example. The data receiver 29 may include circuitry for detecting the perturbation. For example, the data receiver 29 may include a field programmable gate array FPGA 28 or any other circuitry (e.g., hardware, a controller, a processor, etc.) and/or software/firmware for detecting the perturbation in the demodulated output signal. In some embodiments, this detection may be performed by detecting change in frequency of the rectifier input voltage, which in the example of FIG. 5B is the voltage across diode D1.

FIG. 5C shows plots A-F, each of which includes example waveforms for different power levels, illustrating the effect of a perturbation created at the wireless power transmitter 10 by stopping the switching of the switches of the inverter 12. Plot A shows the timing and duration of the perturbation, with the switching of the inverter switches being stopped for the period the “modulation” signal is low. Plot B shows the wireless power transmitter tank current, which is the current through the transmit coil 13. Plot C shows the low pass filtered output power of the rectifier 22 of the wireless power receiver 20, illustrating the trend of decreasing output power in response to the switches of the inverter 12 being turned off. Plot D shows the output voltage of the inverter 12. Plot E shows the input voltage of the wireless power receiver rectifier 22. Plot F shows the output voltage of the rectifier 22 of the wireless power receiver 20. As illustrated in plot F, the perturbation produced by the wireless power transmitter 10 causes an in increase in the frequency of the output voltage of the rectifier 22. This change in frequency can be detected by the data receiver 29.

### Varying the Perturbation

If the detected perturbation is interpreted as a bit (logical high or low), the duration of the perturbation presents a tradeoff between signal strength and efficiency. Creating the perturbation at the wireless power receiver 20 causes power loss because it is not the most efficient way of operating the rectifier 22. The longer the perturbation is applied, the greater the power loss. Therefore, it can be desirable to keep the perturbation short to increase efficiency. However, reducing the period of time the perturbation is applied can make the perturbation more difficult to detect at the wireless power transmitter 10. The higher the transmitted power level, and the lower the magnetic coupling between the transmit and receive coils 13, 21, the more difficult it is to detect the perturbation because the signal to noise ratio decreases.

In some embodiments, the duration of the perturbation may be controlled to vary with system conditions. For example, the perturbation duration may be increased in conditions of high power and/or low magnetic coupling. Conversely, the perturbation duration may be decreased at lower power and/or higher magnetic coupling. Accordingly, the perturbation duration may be adjusted to trade off power loss vs. signal strength depending on the system conditions. In some embodiments, the number of perturbation pulses may be used to achieve the desired signal strength or to shape the perturbation to increase detectability on the side of the data receiver.

The duration of the perturbation and/or number of perturbation pulses may be controlled by a controller 23 of the wireless power receiver 20 or a controller 14 of the wireless power transmitter 10. The wireless power receiver 20 and/or the wireless power transmitter 10 may include a memory for storing a mapping (e.g., a lookup table, a function or expression, etc.) between determined system parameters (e.g., related to power level, magnetic coupling, or other parameters) and characteristics of the perturbation (e.g., duration of a pulse and/or number of pulses) to be applied. The controller 23 and/or 14 may use the mapping to determine the characteristics of the perturbation to be applied.

The system conditions may be detected by the wireless power transmitter 10 and/or the wireless power receiver 20 in any suitable way. The power level and magnetic coupling may be measured (directly or indirectly) so that the duration of the perturbation may be varied. To detect the power level, the wireless power receiver 20 can measure the voltage and/or current received, representing the received power level, or the wireless power transmitter can measure the voltage and/or current of the inverter 12 and/or transmit coil 13, which represents transmitter power level. To detect the magnetic coupling there are a number of options. One is to perform a calibration. A calibration may be performed by controlling the wireless power transmitter 10 to produce a pulse of known strength, and the signal induced at the wireless power receiver 20 can be measured. Another option is to use the error signal of the wireless power receiver 20 as a proxy for the magnetic coupling. For example, the wireless power receiver 20 may measure the error as the difference between the desired strength of the signal received at the wireless power receiver 20 and the actual strength of the received signal (e.g., voltage and/or current). A higher error indicates low coupling between the transmit and receive coils 13, 21. The wireless power receiver 20 or wireless power transmitter 10 may control the perturbation to have a longer duration when the error signal increases in order to increase the signal to noise ratio.

### Encoding Techniques

In some embodiments, data may be encoded in the duration between perturbations or the duration of a perturbation. For example, a quantity (e.g., voltage, current, temperature, error, etc.) may be communicated by controlling the duration between perturbations or the duration of a perturbation. The wireless power transmitter 10 or wireless power receiver 20 may detect (e.g., using a counter or other detection circuitry) the duration of the perturbation or duration between perturbations, and the duration may be mapped (e.g., using a lookup table, function or expression stored in memory) into a value of a quantity. For example, a duration of 20 microseconds may indicate a voltage measurement of 20 V at the wireless power receiver, and a duration of 40 microseconds may indicate a voltage measurement of 10 V. This is an example, and a duration of any value may be mapped into a quantity (e.g., voltage, current, temperature, error, etc.) of any value, with any correlation (e.g., proportional, inversely proportional). Such an encoding technique is described herein as a pulse-encoded, time varying (PETV) communication protocol.

In some embodiments, the error in the received signal detected at the wireless power receiver 20 may be encoded as the duration of the perturbation or the duration between perturbations. In some cases, the duration of the perturbation or the duration between perturbations may be encoded as inversely proportional to the error (i.e., a larger error is encoded as a perturbation of smaller duration). Having the duration be inversely proportional to the error may help the wireless power transfer system 100 to respond more quickly when the error is large.

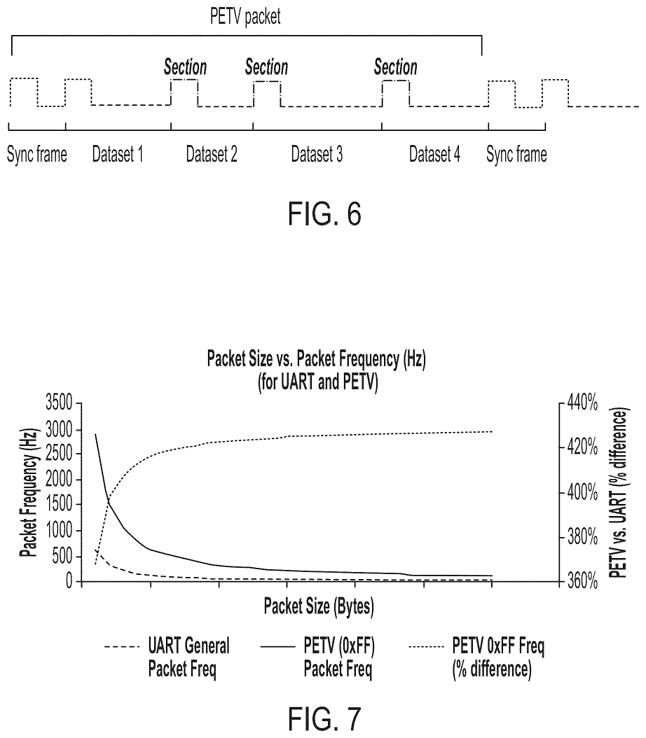

In some embodiments, a plurality of values may be transmitted in a single PETV packet through the use of sectioning packets, as shown in FIG. 6. The sync frame at the beginning of the packet provides reframing and packet edge identification. The dataset <X> contains time-varied encoding of desired data (e.g., header, checksum, payload, etc.). Here the PETV packet is illustrated as including four datasets (e.g., datasets 1-4). However, this is an example, and PETV packets may have any number of datasets, which individually have any length. The section portion of the PETV packet may be a single high pulse intra-framing identification for dataset separation. However, the datasets may be separated in any suitable way, not limited to a high pulse.

Below are examples of advantages of using the PETV protocol for transferring information between a wireless power receiver 20 and a wireless power transmitter 10:
1. Efficiency loss (defined as high-to-low pulse ratio) per packet can be fully defined and constant regardless of the data transmitted
   a. Efficiency loss for a single dataset point may be minimized by communicating the entire value with a single perturbation or high-to-low pulse, as opposed to a discrete pulse train.
   b. An increase in bit-length does not reduce the efficiency as it would for Universal Asynchronous Receiver-Transmitter (UART) (or other similar protocol) where more bits mean more potential perturbations or high-to-low pulses.
2. The time-varying dataset portion of a packet may be used as a “carrier wave” for additional, pulse-encoded data, providing an additional layer of data compression or real-time error detection/correction without explicitly increasing packet length.
3. Transmission frequency can be coupled to a single or multiple dataset value, providing increased or reduced throughput depending on the value output (i.e., system response is automatically accelerated or reduced to increase performance or energy conservation when needed)
   FIG. 7 shows the increased performance of PETV in terms of packet frequency with respect to UART. Packet size may be measured as the number of datasets per packet.

### Peak Detector

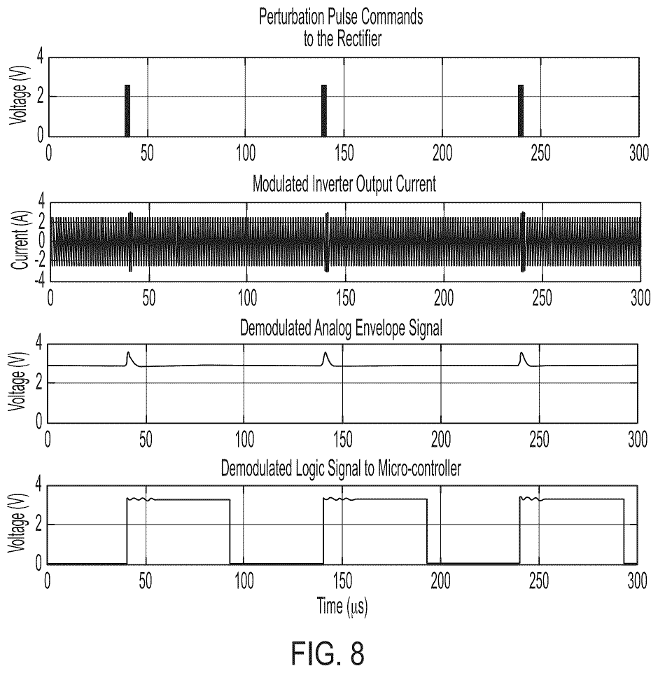

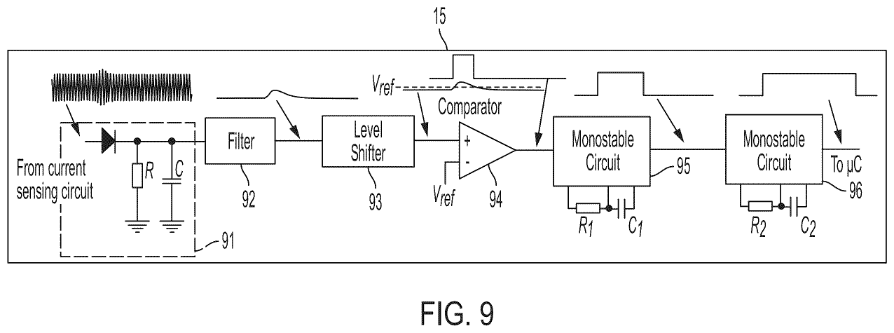

As mentioned above, the data receiver of the telemetry system may be implemented in the wireless power transmitter 10 of the wireless power transfer system 100. The magnitude and duration of the peak in the signal at the data receiver caused by the perturbation depends on the duration of the perturbation. FIG. 8 shows examples of waveforms of the telemetry system including the perturbation pulse commands and the inverter 12 output current, which is the same as the transmit coil 13 current since the transmit coil 13 is driven by the inverter 12. FIG. 9 shows an example of a data receiver 15, according to some embodiments. As the inverter 12 output current is amplitude-modulated, a peak detector, such as a diode-resistor-capacitor (DRC) circuit 91 as shown in FIG. 9, or a synchronous AM demodulation circuit using analog mixer, can be used to generate the envelope of the coil current. The DRC method provides low power consumption. The values of the resistance, R, and capacitance, C, determine the response of the peak detector and the output ripple magnitude. While the RC time-constant should be much larger than the period of the carrier signal, i.e., the switching frequency of the inverter, to minimize the high-frequency ripple content of the envelope signal, it should be as small as possible to maximize the signal transfer rate. In the circuit shown in FIG. 9, a filter 92 is used to filter the incoming signal. The filter 92 may be any suitable filter, such as a low-pass filter for filtering out the high-frequency ripple in the envelope signal so that a small RC value can be used for increasing the speed of the peak detector, or a high-pass filter, for example. In the case of weak magnetic coupling between the transmit and receive coils, the variation of the inverter output current, and thus the envelope signal magnitude, can be very small. A voltage amplifier can be added to the filter 92 to increase the signal-to-noise ratio.

At the output of the filter 92, the steady-state voltage of the envelope signal varies since it is determined by the steady-state current of the inverter output. A level shifter circuit 93 may be included to adjust the steady-state voltage to a level just lower than the reference voltage, V_{ref}, that is applied to the inverting input of the comparator 94 that converts the analog envelope signal to digital pulses. It should be noted that the pulse width of the digital pulses varies and depends on the magnitude and width of the envelope signal. Depending on the requirement of the signal input of the controller 23, 14 (e.g., a microcontroller) for data processing, the digital signal from the comparator output can be directly sent to the controller 23, 14 in some applications. However, in applications where the data communication circuit or the controller needs to receive a digital signal with a fixed pulse width, one or more monostable circuits 95, 96 can be added after the comparator to convert the pulses with varying pulse width to a fixed pulse width.

The shape of the envelope signal depends on many factors, such as the transferred power and coupling coefficient of the coils 13, 21. In many cases, the shape of the envelope signal is similar to that shown in FIG. 9. The envelope voltage rises quickly after the shorting pulse and then decays monotonically with negligible ringing effect. However, in some cases the envelope may not decay monotonically but decay with ringing, then undesired multiple pulses may be generated at the comparator's output and the pulse width of the output pulse signal of the monostable circuit would be extended and jumps around, depending on the number of pulses generated due to the ringing. To solve this problem, two monostable circuits 95, 96 can be used. The first monostable circuit 95 is used to generate a pulse with a shorter pulse width, which is set by the values of R1 and C1. The pulse width should be longer than the envelope decay time to make sure its output is a single pulse. Although the pulse width of this shorter pulse may be varying, it is a single pulse instead of multiple pulses so the output of the second monostable circuit 96 would have a fixed pulse width, which is set by the values of R2 and C2.

Alternatively or additionally, in some embodiments, the circuit and/or techniques shown in FIG. 9 may be used at the wireless power receiver 20 as data receiver 29.

As discussed above, the controllers described herein may be implemented by any suitable type of circuitry. For example, the controllers may be implemented using hardware or a combination of hardware and software. When implemented using software, suitable software code can be executed on any suitable processor (e.g., a microprocessor) or collection of processors. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, or other tangible, non-transitory computer-readable storage medium) encoded with a computer program (i.e., a plurality of executable instructions) that, when executed on one or more processors, performs the above-discussed functions of one or more embodiments. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 25%, optionally within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1.-12. (canceled)

13. A method of receiving data in a wireless power system that includes a wireless power transmitter and a wireless power receiver, the method comprising:
detecting, by the wireless power receiver or a wireless power transmitter, a perturbation in coupling of power transfer between the wireless power receiver and the wireless power transmitter.

14. The method of claim 13, wherein the detecting of the perturbation comprises detecting a change in amplitude of a signal produced through the coupling.

15. The method of claim 14, wherein the detecting of the change in amplitude comprises detecting an amplitude exceeding a threshold to produce a pulse, and providing the pulse to a monostable circuit to provide a second pulse of fixed width.

16. The method of claim 13, wherein the detecting comprises detecting a change in frequency of a signal produced though the coupling.

17. The method of claim 16, wherein the detecting of the change in frequency is performed at least in part by detecting signal amplitudes exceeding a threshold to produce pulses, and detecting an interval between the pulses.

18.-23. (canceled)

24. An apparatus for controlling transmitting data in a wireless power system, the apparatus comprising:
a controller configured to control a power switch of a wireless power transmitter or a wireless power receiver to create a perturbation that transmits information from the wireless power transmitter or wireless power receiver to the other of the wireless power transmitter and wireless power receiver.

25. The apparatus of claim 24, wherein the controller is configured to modulate a power switch of a rectifier of the wireless power receiver.

26. The apparatus of claim 25, wherein the power switch is coupled in parallel with a diode of the rectifier.

27. The apparatus of claim 24, wherein the controller is configured to modulate a power switch of an inverter of the wireless power transmitter to create the perturbation.

28. The apparatus of claim 27, wherein the controller is configured to stop switching of the power switch of the inverter to create the perturbation.

29. The apparatus of claim 25, wherein the controller is configured to turn on one or more low-side power switches of the rectifier or inverter to create the perturbation.

30. The apparatus of claim 25, wherein the controller is configured to hold one or more power switches of the rectifier or inverter in an existing state past a point in time of an alternating current waveform at which the one or more power switches switch when no perturbation is created.

31. The apparatus of claim 25, wherein the controller is configured to vary a duration between perturbations or a duration of the perturbation based on information regarding one or more system parameters.

32. The apparatus of claim 31, wherein the one or more system parameters comprises power level, magnetic coupling and/or an error signal.

33. The apparatus of claim 25, wherein the controller is configured to vary a duration between perturbations or a duration of the perturbation to encode information in a duration of the perturbation or a duration between perturbations.

34. (canceled)

35. (canceled)

36. An apparatus for receiving data in a wireless power system that includes a wireless power transmitter and a wireless power receiver, the apparatus comprising:
a data receiver configured to detect a perturbation in a coupling between the wireless power receiver and the wireless power transmitter.

37. The apparatus of claim 36, wherein the data receiver is configured to detect a change in amplitude of a signal produced through the coupling.

38. The apparatus of claim 37, wherein the data receiver is configured to detect an amplitude exceeding a threshold to produce a pulse, and provide the pulse to a monostable circuit to provide a second pulse of fixed width.

39. The apparatus of claim 36, wherein the data receiver is configured to detect a change in frequency of a signal produced though the coupling.

40. The apparatus of claim 39, wherein the data receiver is configured to detect the change in frequency at least in part by detecting signal amplitudes exceeding a threshold to produce pulses, and detecting an interval between the pulses.
